(19) United States
(12) Patent Application Publication
(10) Pub. No.: US 2013/0084426 A1
(43) Pub. Date: Apr. 4, 2013

(54) SURFACE COATING AND FUSER MEMBER

(71) Applicants: Yu Qi, Oakville (CA); Carolyn P. Moorlag, Mississauga (CA); Nan-Xing Hu, Oakville (CA); Kurt I. Halfyard, Mississauga (CA); Gordon Sisler, St. Catharines (CA); Edward G. Zwartz, Mississauga (CA); Erwin Ruiz, Rochester, NY (US); Alan R. Kuntz, Webster, NY (US); Guiqin Song, Milton (CA)

(72) Inventors: Yu Qi, Oakville (CA); Carolyn P. Moorlag, Mississauga (CA); Nan-Xing Hu, Oakville (CA); Kurt I. Halfyard, Mississauga (CA); Gordon Sisler, St. Catharines (CA); Edward G. Zwartz, Mississauga (CA); Erwin Ruiz, Rochester, NY (US); Alan R. Kuntz, Webster, NY (US); Guiqin Song, Milton (CA)

(73) Assignee: XEROX CORPORATION, Norwalk, CT (US)

(21) Appl. No.: 13/251,364

(22) Filed: Oct. 3, 2011

(51) Int. Cl. B32B 3/00; B32B 5/00

(52) U.S. Cl. 428/141; 428/336

(57) ABSTRACT

The present teachings disclose a coating that includes a inner layer having a first modulus and a first roughness; and a surface layer having a second modulus. The first modulus is greater than the second modulus. When the coating is subjected to a nip pressure the surface of the coating exhibits a surface roughness approximately equal to the first roughness.

### BACKGROUND

1. Field of Use

The present teachings relate generally to surface coatings for electrophotographic devices and processes and, more particularly, to surface coatings for providing controllable image gloss levels.

2. Background

Electrophotographic marking is performed by exposing a light image representation of a desired document onto a substantially uniformly charged photoreceptor. In response to that light image, the photoreceptor discharges to create an electrostatic latent image of the desired document on the photoreceptor's surface. Toner particles are then deposited onto that latent image to form a toner image. That toner image is then transferred from the photoreceptor onto a print medium such as a sheet of paper. The transferred toner image is then fused to the print medium, usually using heat and/or pressure.

Gloss is a property of a surface that relates to specular reflection. Specular reflection is a sharply defined light beam resulting from reflection off a smooth, uniform surface. Gloss follows the law of reflection which states that when a ray of light reflects off a surface, the angle of incidence is equal to the angle of reflection. Gloss properties are generally measured in gardner gloss units (ggu) by a gloss meter.

There is a desire in the electrographic printing industry to control fused image gloss of both monochrome and color prints to expand electrographic printing color applications.

### SUMMARY

According to an embodiment there is provided a coating comprising a inner layer comprising a first modulus and a first roughness; and a surface layer comprising a second modulus. The first modulus is greater than the second modulus. When the coating is subjected to a nip pressure the surface of the coating exhibits a surface roughness approximately equal to the first roughness.

According to another embodiment there is provided a fuser member comprising a substrate; a functional layer disposed on the substrate and an outer coating disposed on the functional layer. The outer coating comprises a inner layer comprising a first modulus and a first roughness and a surface layer comprising a second modulus wherein the first modulus is greater than the second modulus. When the coating is subjected to a nip pressure the surface of the coating exhibits a surface roughness approximately equal to the first roughness.

According to another embodiment there is provided a coating comprising a inner layer comprising fluoroelastomer having dispersed therein aerogel particles and a surface layer comprising a fluoroelastomer disposed on the inner layer. The surface layer comprises a thickness of from about 1 μm to about 20 μm.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 is a schematic illustration of an image apparatus.

FIG. 2 is a schematic of an embodiment of a fuser member.

FIG. 3 is a schematic of an embodiment of a fuser member.

FIG. 4 shows roll gloss versus print count for various fuser members.

It should be noted that some details of the FIGS. have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

Illustrations with respect to one or more implementations, alterations and/or modifications can be made to the illustrated examples without departing from the spirit and scope of the appended claims. In addition, while a particular feature may have been disclosed with respect to only one of several implementations, such features may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Notwithstanding that the numerical ranges and parameters setting forth the broad scope of embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

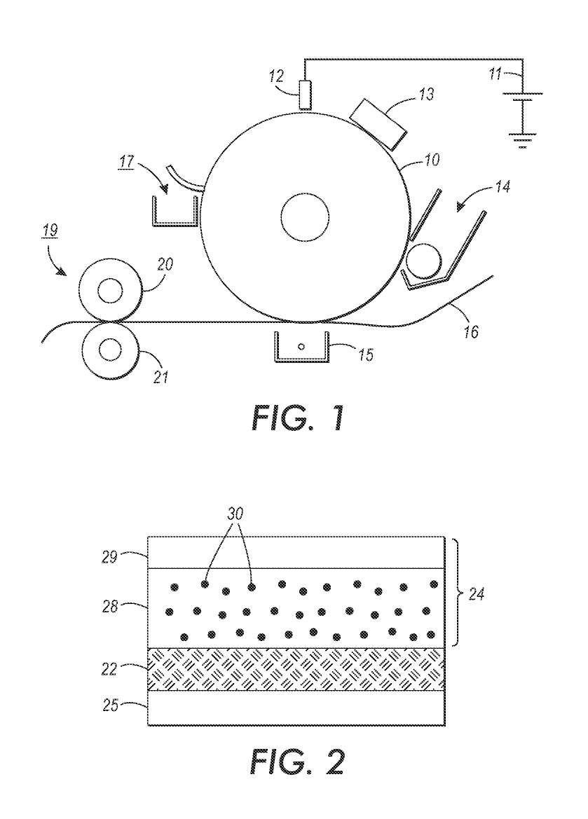

Referring to FIG. 1, in a typical electrostatographic reproducing apparatus, a light image of an original to be copied is recorded in the form of an electrostatic latent image upon a photosensitive member and the latent image is subsequently rendered visible by the application of electroscopic thermoplastic resin particles, which are commonly referred to as toner. Specifically, a photoreceptor 10 is charged on its surface by means of a charger 12, to which a voltage has been supplied from a power supply 11. The photoreceptor 10 is then imagewise exposed to light from an optical system or an image input apparatus 13, such as a laser and light emitting diode, to form an electrostatic latent image thereon. Generally, the electrostatic latent image is developed by bringing a developer mixture from a developer station 14 into contact therewith. Development can be effected by use of a magnetic brush, powder cloud, or other known development process. A dry developer mixture usually comprises carrier granules having toner particles adhering triboelectrically thereto. Toner particles are attracted from the carrier granules to the latent image forming a toner powder image thereon. Alternatively, a liquid developer material may be employed, which includes a liquid carrier having toner particles dispersed therein. The liquid developer material is advanced into contact with the electrostatic latent image and the toner particles are deposited thereon in image configuration.

After the toner particles have been deposited on the photoconductive surface in image configuration, they are transferred to a copy sheet 16 by a transfer means 15, which can be pressure transfer or electrostatic transfer. Alternatively, the developed image can be transferred to an intermediate transfer member, or bias transfer member, and subsequently transferred to a copy sheet. Examples of copy substrates include paper, transparency material such as polyester, polycarbonate, or the like, cloth, wood, or any other desired material upon which the finished image will be situated.

After the transfer of the developed image is completed, copy sheet 16 advances to a fusing station 19, depicted in FIG. 1 as a fuser roll 20 and a pressure roll 21 (although any other fusing components such as fuser belt in contact with a pressure roll, fuser roll in contact with pressure belt, and the like, are suitable for use with the present apparatus), wherein the developed image is fused to copy sheet 16 by passing copy sheet 16 between the fusing and pressure members, thereby forming a permanent image. Alternatively, transfer and fusing can be effected by a transfix application.

Subsequent to transfer, photoreceptor 10 advances to a cleaning station 17, wherein any toner left on photoreceptor 10 is cleaned therefrom by use of a blade (as shown in FIG. 1), brush, or other cleaning apparatus.

FIG. 2 is an enlarged schematic view of an embodiment of a fuser member, demonstrating the various possible layers. As shown in FIG. 2, a substrate 25 has an optional intermediate layer 22 thereon. On intermediate layer 22 is positioned a release layer 24, described in more detail below.

### Substrate Layer

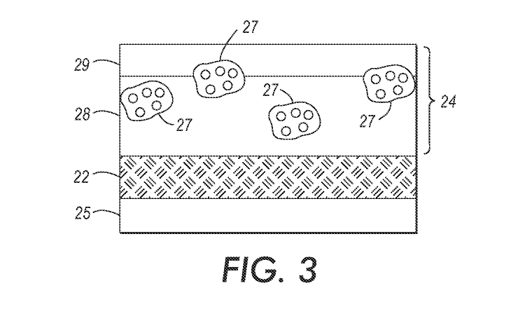

The substrate 25 in FIGS. 2 and 3 can be in a form of, for example, a belt, plate, and/or cylindrical drum for the disclosed fuser member. The substrate of the fusing member is not limited, as long as it can provide high strength and physical properties that do not degrade at a fusing temperature. Specifically, the substrate can be made from a metal, such as aluminum or stainless steel or a plastic of a heat-resistant resin. Examples of the heat-resistant resin include a polyimide, an aromatic polyimide, polyether imide, polyphthalamide, polyester, and a liquid crystal material such as a thermotropic liquid crystal polymer and the like. The thickness of the substrate falls within a range where rigidity and flexibility enabling the fusing belt to be repeatedly turned can be compatibly established, for instance, ranging from about 10 to about 200 micrometers or from about 30 to about 100 micrometers.

### Intermediate Layer

Examples of materials used for the functional intermediate layer 22 (also referred to as a cushioning layer) shown in FIGS. 2 and 3 include fluorosilicones, silicone rubbers such as room temperature vulcanization (RTV) silicone rubbers, high temperature vulcanization (HTV) silicone rubbers, and low temperature vulcanization (LTV) silicone rubbers. These rubbers are known and readily available commercially, such as SILASTIC® 735 black RTV and SILASTIC® 732 RTV, both from Dow Corning; 106 RTV Silicone Rubber and 90 RTV Silicone Rubber, both from General Electric; and JCR6115CLEAR HTV and SE4705U HTV silicone rubbers from Dow Corning Toray Silicones. Other suitable silicone materials include siloxanes (such as polydimethylsiloxanes); fluorosilicones such as Silicone Rubber 552, available from Sampson Coatings, Richmond, Virginia; liquid silicone rubbers such as vinyl crosslinked heat curable rubbers or silanol room temperature crosslinked materials; and the like. Another specific example is Dow Corning Sylgard 182. Commercially available LSR rubbers include Dow Corning Q3-6395, Q3-6396, SILASTIC® 590 LSR, SILASTIC® 591 LSR, SILASTIC® 595 LSR, SILASTIC® 596 LSR, and SILASTIC® 598 LSR from Dow Corning. The functional layers provide elasticity and can be mixed with inorganic particles, for example SiC or Al₂O₃, as required.

Other examples of the materials suitable for use as intermediate layer 22 also include fluoroelastomers. Fluoroelastomers are from the class of 1) copolymers of two of vinylidenefluoride, hexafluoropropylene, and tetrafluoroethylene; 2) terpolymers of vinylidenefluoride, hexafluoropropylene, and tetrafluoroethylene; and 3) tetrapolymers of vinylidenefluoride, hexafluoropropylene, tetrafluoroethylene, and a cure site monomer. These fluoroelastomers are known commercially under various designations such as VITON A®, VITON B® VITON E® VITON E 60C®, VITON E430®, VITON 910®, VITON GH®; VITON GF®; and VITON ETP®. The VITON® designation is a Trademark of E.I. DuPont de Nemours, Inc. The cure site monomer can be 4-bromoperfluorobutene-1,1,1-dihydro-4-bromoperfluorobutene-1,3-bromoperfluoropropene-1 1,1-dihydro-3-bromoperfluoropropene-1, or any other suitable, known cure site monomer, such as those commercially available from DuPont. Other commercially available fluoropolymers include FLUOREL 2170®, FLUOREL 2174®, FLUOREL 2176®, FLUOREL 2177® and FLUOREL LVS 76®, FLUOREL® being a registered trademark of 3M Company. Additional commercially available materials include AFLAS™ a poly(propylene-tetrafluoroethylene), and FLUOREL II® (LII900) a poly(propylene-tetrafluoroethylenevinylidenefluoride), both also available from 3M Company, as well as the Tecnoflons identified as FOR-60KIR , FOR-LHF® NM® FOR-THF®, FOR-TFS® TH® NH®, P757 TNS®, T439 PL958® BR9151® and TN505®, available from Ausimont.

Examples of three known fluoroelastomers are (1) a class of copolymers of two of vinylidenefluoride, hexafluoropropylene, and tetrafluoroethylene, such as those known commercially as VITON A®; (2) a class of terpolymers of vinylidenefluoride, hexafluoropropylene, and tetrafluoroethylene known commercially as VITON B®; and (3) a class of tetrapolymers of vinylidenefluoride, hexafluoropropylene, tetrafluoroethylene, and a cure site monomer known commercially as VITON GH® or VITON GF®.

The fluoroelastomers VITON GH® and VITON GF® have relatively low amounts of vinylidenefluoride. The VITON GF® and VITON GH® have about 35 weight percent of vinylidenefluoride, about 34 weight percent of hexafluoropropylene, and about 29 weight percent of tetrafluoroethylene, with about 2 weight percent cure site monomer.

The thickness of the intermediate layer 22 is from about 30 microns to about 1,000 microns, or from about 100 microns to about 800 microns, or from about 150 to about 500 microns.

### Adhesive Layer(s)

Optionally, any known and available suitable adhesive layer, also referred to as a primer layer, may be positioned between the release layer 24, the intermediate layer 22 and the substrate 25. Examples of suitable adhesives include silanes such as amino silanes (such as, for example, HV Primer 10 from Dow Corning), titanates, zirconates, aluminates, and the like, and mixtures thereof. In an embodiment, an adhesive in from about 0.001 percent to about 10 percent solution can be wiped on the substrate. The adhesive layer can be coated on the substrate, or on the outer layer, to a thickness of from about 2 nanometers to about 2,000 nanometers, or from about 2 nanometers to about 500 nanometers. The adhesive can be coated by any suitable known technique, including spray coating or wiping.

### Release Layer

In FIG. 2, an embodiment of the release layer 24 is shown. The multi-layer coating for the release layer 24 includes an innerlayer 28 (also referred to as a rough layer) with the desired roughness and an outmost layer 29 (also referred to as a surface layer) disposed on the inner layer 28 or rough layer. The outmost layer 29 has a modulus lower than that of the inner layer 28. The outmost layer 29 may or may not inherit the roughness from the underneath layer as it is, however, under pressure such as nip pressure during fusing process, it possesses a surface roughness similar to that of the underneath rough layer. The modulus of the inner layer 28 in relation to the outermost layer 29 can be controlled by adding fillers 30. The modulus of the inner layer 28 in relation to the outermost layer 29 can be also be controlled by having inner layer 28 made of a material having a modulus higher than the outermost layer 29. The roughness of the inner layer 28 in relation to the outermost layer 29 can be controlled by adding fillers 30. The roughness of the inner layer 28 in relation to the outermost layer 29 can be also be controlled by embossing or patterning inner layer 28 to a desired roughness.

In FIG. 3, another embodiment of a release layer 24 is shown. In FIG. 3 the release layer 24 includes an inner layer 28 with the desired roughness provided by aerogel particles 27 dispersed in a polymer 26. The outmost layer 29 is disposed on the inner layer 28 and has a modulus lower than that of the inner layer 28. The outmost layer 29 may or may not inherit the roughness from the underneath layer as it is, however, under pressure such as nip pressure during fusing process, it possesses a surface roughness similar to that of the underneath rough layer. Measured at ambient conditions, the ranges for the modulus of the inner layer 28 are from about 500 psi to about 10,000 psi, or from about 600 psi to about 5,000 psi, or from about 800 psi to about 1500 psi. The ranges for the modulus of the outmost layer 29 are from about 200 psi to about 2000 psi, or from about 300 psi to about 1500 psi, or from about 300 psi to about 1000 psi. The ranges for the surface roughness (Sq) of the inner layer 28 are from about 1.5 μm to about 6 μm, from about 2.5 μm to about 5 μm, from about 3 μm to about 4 μm.

Lowering print gloss is required for certain applications. Lowering print gloss can be achieved by modification of the fuser roll. Reducing print gloss by adding appropriate fillers to the fuser roll is a lower cost option than modifying toner formulations. It is possible to produce a series of fuser rolls with varying amounts of filler that allows customers to choose the gloss of the prints by selecting the appropriate fuser member. To this end, a composite iGen fuser topcoat design containing silica arogel particles dispersed in a fluoroelastomer matrix is described in (U.S. patent application Ser. No. 13/053,730 filed Mar. 22, 2011) and incorporated in its entirety by reference herein. In addition, a composite iGen fuser topcoat design containing silica aerogel particles dispersed in a fluoroplastic matrix is described in (U.S. patent application Ser. No. 13/053,418 filed Mar. 22, 2011) and incorporated in its entirety by reference herein. When aerogel particles are incorporated into iGen fuser topcoats, the fuser topcoat has significantly lower gloss than the iGen3 control roll. Increasing the amount of aerogel particles in the topcoat layer decreases gloss.

Based on the long-term accelerated iGen machine testing, it was found that the print gloss increases over time for fusers having topcoats containing aerogel particles. In addition gloss variation within a print is observed for fusers having topcoats containing aerogel particles. These issues are likely caused by the deformation of the filler particles, e.g. aerogel particles, accelerated abrasion of the topcoat or release layer, and contamination of the topcoat. A multi-layer approach is provided herein to mitigate these effects, and allow for a wide variety of materials/process.

The intent of the dual layer design of release layer 24 is to cover up the inner layer 28 with a thin layer surface layer 29 or outermost layer 29 which maintains the surface by minimizing abrasion or push-in of the filler particles in the inner layer 28. Without a surface layer 29 a ‘break-in’ rise in gloss over the first 10-25 thousand prints occurs. Without a surface layer 29 there also as a within-print mottle of gloss around the toner and non-toner areas on print. By covering inner layer 28 with an outermost layer 29 minimization of print defects is provided, while still achieving low gloss on print.

A dual layer topcoat design that preserves necessary surface roughness results in low-gloss prints, while minimizing gloss defects and glossy break-in period of single layer on said prints over life-of-fuser roller is described. This is specifically for iGen3 Roller system, but can be applied to belt surfaces.

The advantages of the multi-layer release layer 24 include decoupling the low gloss function from the common fuser surface requirements such as toner release, wear and contamination resistance. In addition, wear and contamination can be addressed by the outermost layer 29 composition while still obtaining the low gloss functionality through the inner layer 28. Various materials that provide release and mechanical robustness can be used as outermost layer 29, e.g. a fluoroelastomer or a fluorplastic. Various materials/processes that provide roughness for the inner layer 28 can be applied, e.g. incorporation of fillers, embossing and imprinting. Inner layer 28 can be fluoropolymer matrix that includes fluoroplastics and fluorelastomers.

In embodiments, the material suitable for the outmost layer 29 can be a fluoroplastic or fluoroelastomer so long as the modulus is less than the first layer. In embodiments, the material 26 suitable for the inner layer 28 can also be a fluoroplastic or fluoroelastomer so long as the modulus is less than the first layer. The roughness of the inner layer 28 may be generated by incorporating fillers, shown as particles 30, or embossing or imprinting the inner layer 28. The thickness of the outmost layer 29 is from about 1 μm to about 20 μm, or in embodiments from about 2 μm to about 15 μm, or in embodiments from about 3 μm to about 10 μm. The thickness of the inner layer 28 is from about 10 μm to about 200 μm, or in embodiments from about 10 μm to about 100 μm, or in embodiments from about 10 μm to about 50 μm. The multi-layer coating can be prepared by various coating techniques such as flow-coating, spray-coating, and dip-coating. Using gloss to define the surface roughness, the roughness providing layer has a gloss range from about 3 ggu to about 60 ggu at 75 gloss average, or from about 5 ggu to about 40 ggu at 75 gloss average, or from about 10 ggu to about 20 ggu at 75 gloss average.

Fluoroplastics suitable for use as the polymer binder 26 inner layer 28 or the material of outermost layer 29 in the formulation and release layer 24 described herein include polytetrafluoroethylene (PTFE), perfluoroalkoxy polymer resin (PFA), copolymers of polytetrafluoroethylene and perfluoromethylvinylether and mixtures thereof. The fluoroplastic provides chemical and thermal stability and has a low surface energy. The fluoroplastic has a melting temperature of from about 100° C. to about 350° C. or from about 120 ° C. to about 330° C.

Examples of three known fluoroelastomers as a material for the outermost layer 29 or the first layer 28 are (1) a class of copolymers of two of vinylidenefluoride, hexafluoropropylene, and tetrafluoroethylene, such as those known commercially as VITON A®; (2) a class of terpolymers of vinylidenefluoride, hexafluoropropylene, and tetrafluoroethylene known commercially as VITON B®; and (3) a class of tetrapolymers of vinylidenefluoride, hexafluoropropylene, tetrafluoroethylene, and cure site monomer known commercially as VITON GH® or VITON GF®.

The fluoroelastomers VITON GH® and VITON GF® have relatively low amounts of vinylidenefluoride. The VITON GF® and VITON GH® have about 35 weight percent of vinylidenefluoride, about 34 weight percent of hexafluoropropylene, and about 29 weight percent of tetrafluoroethylene, with about 2 weight percent cure site monomer.

Commercially available fluoroelastomers used for the outmost layer 29 or inner layer 28 in FIGS. 2 and 3 can include, such as, for example, VITON® A (copolymers of hexafluoropropylene (HFP) and vinylidene fluoride (VDF or VF2)), VITON® B, (terpolymers of tetrafluoroethylene (TFE), vinylidene fluoride (VDF) and hexafluoropropylene (HFP)), and VITON® GF, (tetrapolymers of TFE, VF2, HFP), as well as VITON® E, VITON® E 60C, VITON® E430, VITON® 910, VITON® GH and VITON® GF. The VITON® designations are trademarks of E.I. DuPont de Nemours, Inc. (Wilmington, Del.).

Examples of particles 30 (FIG. 2) or fillers that can be included inner layer 28 include carbon nanotubes (CNT); carbon blacks such as carbon black, graphite, acetylene black, aerogel particles (shown as 27 in FIG. 3), graphite, graphene, fluorinated carbon black, and the like; metal, metal oxides and doped metal oxides, such as tin oxide, antimony dioxide, antimony-doped tin oxide, titanium dioxide, indium oxide, zinc oxide, indium oxide, indium-doped tin trioxide, silicon carbide, metal carbide and the like; and mixtures thereof. The particles 30 or fillers may be present in an amount of from about 0.1 volume percent to about 30 volume percent, or from about 0.5 volume percent to about 20 volume percent, or from about 1 volume percent to about 10 volume percent of total solids to the first layer 28.

As an example, for a low gloss fuser application, the material suitable for the outmost layer 29 is a cured fluoroelastomer such as Viton, and the material useful for the underneath roughness providing layer is fluoropolymer such as THV. THV is a polymer of tetrafluoroethylene, hexafluoropropylene and vinylidene fluoride. The roughness may be generated by incorporating fillers, shown as particles 30, or embossing or imprinting the inner layer 28. The multi-layer coating can be prepared by various coating techniques such as flow-coating, spray-coating, and dip-coating. Using gloss to define the surface roughness, the roughness providing layer has a gloss range from about 3 ggu to about 60 ggu at 75 gloss average, or from about 5 ggu to about 40 ggu at 75 gloss average, or from about 10 ggu to about 20 ggu at 75 gloss average.

Aerogels may be described, in general terms, as gels that have been dried to a solid phase by removing pore fluid and replacing the pore fluid with air. As used herein, an “aerogel” refers to a material that is generally a very low density ceramic solid, typically formed from a gel. The term “aerogel” is thus used to indicate gels that have been dried so that the gel shrinks little during drying, preserving its porosity and related characteristics. In contrast, “hydrogel” is used to describe wet gels in which pore fluids are aqueous fluids. The term “pore fluid” describes fluid contained within pore structures during formation of the pore element(s). Upon drying, such as by supercritical drying, aerogel particles 27 are formed that contain a significant amount of air, resulting in a low density solid and a high surface area. In various embodiments, aerogels are thus low-density microcellular materials characterized by low mass densities, large specific surface areas and very high porosities. In particular, aerogels are characterized by their unique structures that comprise a large number of small inter-connected pores. After the solvent is removed, the polymerized material is pyrolyzed in an inert atmosphere to form the aerogel.

Any suitable aerogel component can be used. In embodiments, the aerogel component can be, for example, selected from inorganic aerogels, organic aerogels, carbon aerogels, and mixtures thereof. In particular embodiments, ceramic aerogels can be suitably used. These aerogels are typically composed of silica, but may also be composed of metal oxides, such as alumina, titania and zirconia, or carbon, and can optionally be doped with other elements such as a metal. In some embodiments, the aerogel component can comprise aerogels chosen from polymeric aerogels, colloidal aerogels, and mixtures thereof.

The aerogel component can be either formed initially as the desired sized particles, or can be formed as larger particles and then reduced in size to the desired size. For example, formed aerogel materials can be ground, or they can be directly formed as nano to micron sized aerogel particles.

Aerogel particles 27 (FIG. 3) of embodiments may have porosities of from about 50 percent to about 99.9 percent, in which the aerogel can contain 99.9 percent empty space. In embodiments the aerogel particles have porosities of from about 50 percent to about 99.0 percent, or from 50 percent to about 98 percent. In embodiments, the pores of aerogel components may have diameters of from about 2 nm to about 500 nm, or from about 10 nm to about 400 nm or from about 20 nm to about 100 nm. In particular embodiments, aerogel components may have porosities of more than 50% pores with diameters of less than 100 nm and even less than about 20 nm. In embodiments, the aerogel components may be in the form of particles having a shape that is spherical, or near-spherical, cylindrical, rod-like, bead-like, cubic, platelet-like, and the like.

In embodiments, the aerogel components include aerogel particles 27, powders, or dispersions ranging in average volume particle size of from about 1 μm to about 100 μm, or about 3 μm to about 50 μm, or about 5 μm to 20 μm. The aerogel components can include aerogel particles that appear as well dispersed single particles or as agglomerates of more than one particle or groups of particles within the polymer material.

Generally, the type, porosity, pore size, and amount of aerogel used for a particular embodiment may be chosen based upon the desired properties of the resultant composition and upon the properties of the polymers and solutions thereof into which the aerogel is being combined. For example, if a pre-polymer (such as a low molecular weight polyurethane monomer that has a relatively low process viscosity, for example less than 10 centistokes) is chosen for use in an embodiment, then a high porosity, for example greater than 80%, and high specific surface area, for example greater than about 500 m²/gm, aerogel having relatively small pore size, for example less than about 100 nm, may be mixed at relatively high concentrations, for example greater than about 2 weight percent to about 20 weight percent, into the pre-polymer by use of moderate-to-high energy mixing techniques, for example by controlled temperature, high shear and/or blending. If a hydrophilic-type aerogel is used, upon cross-linking and curing/post curing the pre-polymer to form an infinitely long matrix of polymer and aerogel filler, the resultant composite may exhibit improved hydrophobicity and increased hardness when compared to a similarly prepared sample of unfilled polymer. The improved hydrophobicity may be derived from the polymer and aerogel interacting during the liquid-phase processing whereby a portion of the molecular chain of the polymer interpenetrates into the pores of the aerogel and the non-pore regions of the aerogel serves to occupy some or all of the intermolecular space where water molecules could otherwise enter and occupy.

The continuous and monolithic structure of interconnecting pores that characterizes aerogel components also leads to high surface areas and, depending upon the material used to make the aerogel, the electrical conductivity may range from highly thermally and electrically conducting to highly thermally and electrically insulating. Further, aerogel components in embodiments may have surface areas ranging from about 400 m²/g to about 1200 m²/g, such as from about 500 m²/g to about 1200 m²/g, or from about 700 m²/g to about 900 m²/g. In embodiments, aerogel components may have electrical resistivities greater than about 1.0×10⁻⁴ Ω-cm, such as in a range of from about 0.01 Ω-cm to about 1.0×10¹⁶ Ω-cm, from about 1 Ω-cm to about 1.0×10⁸ Ω-cm, or from about 50 Ω-cm to about 750,000 Ω-cm. Different types of aerogels used in various embodiments may also have electrical resistivities that span from conductive, about 0.01 to about 1.00 Ω-cm, to insulating, more than about 10¹⁶ Ω-cm. Conductive aerogels of embodiments, such as carbon aerogels, may be combined with other conductive fillers to produce combinations of physical, mechanical, and electrical properties that are otherwise difficult to obtain.

Aerogels that can suitably be used in embodiments may be divided into three major categories: inorganic aerogels, organic aerogels and carbon aerogels. In embodiments, the fuser member layer may contain one or more aerogels chosen from inorganic aerogels, organic aerogels, carbon aerogels and mixtures thereof. For example, embodiments can include multiple aerogels of the same type, such as combinations of two or more inorganic aerogels, combinations of two or more organic aerogels, or combinations of two or more carbon aerogels, or can include multiple aerogels of different types, such as one or more inorganic aerogels, one or more organic aerogels, and/or one or more carbon aerogels. For example, a chemically modified, hydrophobic silica aerogel may be combined with a high electrical conductivity carbon aerogel to simultaneously modify the hydrophobic and electrical properties of a composite and achieve a desired target level of each property.

Inorganic aerogels, such as silica aerogels, are generally formed by sol-gel polycondensation of metal oxides to form highly cross-linked, transparent hydrogels. These hydrogels are subjected to supercritical drying to form inorganic aerogels.

Organic aerogels are generally formed by sol-gel polycondensation of resorcinol and formaldehyde. These hydrogels are subjected to supercritical drying to form organic aerogels.

Carbon aerogels are generally formed by pyrolyzing organic aerogels in an inert atmosphere. Carbon aerogels are composed of covalently bonded, nanometer-sized particles that are arranged in a three-dimensional network. Carbon aerogels, unlike high surface area carbon powders, have oxygen-free surfaces, which can be chemically modified to increase their compatibility with polymer matrices. In addition, carbon aerogels are generally electrically conductive, having electrical resistivities of from about 0.005 Ω-cm to about 1.00 Ω-cm. In particular embodiments, the composite may contain one or more carbon aerogels and/or blends of one or more carbon aerogels with one or more inorganic and/or organic aerogels.

Carbon aerogels that may be included in embodiments exhibit two morphological types, polymeric and colloidal, which have distinct characteristics. The morphological type of a carbon aerogel depends on the details of the aerogel's preparation, but both types result from the kinetic aggregation of molecular clusters. That is, nanopores, primary particles of carbon aerogels that may be less than 20 Å (Angstroms) and that are composed of intertwined nanocrystalline graphitic ribbons, cluster to form secondary particles, or mesopores, which may be from about 20 Å to about 500 Å. These mesopores can form chains to create a porous carbon aerogel matrix. The carbon aerogel matrix may be dispersed, in embodiments, into polymeric matrices by, for example, suitable melt blending or solvent mixing techniques.

In embodiments, carbon aerogels may be combined with, coated, or doped with a metal to improve conductivity, magnetic susceptibility, and/or dispersibility. Metal-doped carbon aerogels may be used in embodiments alone or in blends with other carbon aerogels and/or inorganic or organic aerogels. Any suitable metal, or mixture of metals, metal oxides and alloys may be included in embodiments in which metal-doped carbon aerogels are used. In particular embodiments, and in specific embodiments, the carbon aerogels may doped with one or more metals chosen from transition metals (as defined by the Periodic Table of the Elements) and aluminum, zinc, gallium, germanium, cadmium, indium, tin, mercury, thallium and lead. In particular embodiments, carbon aerogels are doped with copper, nickel, tin, lead, silver, gold, zinc, iron, chromium, manganese, tungsten, aluminum, platinum, palladium, and/or ruthenium. For example, in embodiments, copper-doped carbon aerogels, ruthenium-doped carbon aerogels and mixtures thereof may be included in the composite.

For example as noted earlier, in embodiments in which the aerogel components comprise nanometer-scale particles 27, these particles or portions thereof can occupy inter- and intra-molecular spaces within the molecular lattice structure of the polymer, and thus can prevent water molecules from becoming incorporated into those molecular-scale spaces. Such blocking may decrease the hydrophilicity of the overall composite. In addition, many aerogels are hydrophobic. Incorporation of hydrophobic aerogel components may also decrease the hydrophilicity of the composites of embodiments. Composites having decreased hydrophilicity, and any components formed from such composites, have improved environmental stability, particularly under conditions of cycling between low and high humidity.

The aerogel particles 27 can include surface functionalities selected from the group of alkylsilane, alkylchlorosilane, alkylsiloxane, polydimethylsiloxane, aminosilane and methacrylsilane. In embodiments, the surface treatment material that contains functionality reactive to aerogel that will result in modified surface interactions. Surface treatment also helps enable non-stick interaction on the composition surface.

In addition, the porous aerogel particles 27 may interpenetrate or intertwine with the fluoropolymer and thereby strengthen the polymeric lattice. The mechanical properties of the overall composite of embodiments in which aerogel particles have interpenetrated or interspersed with the polymeric lattice may thus be enhanced and stabilized.

For example, in one embodiment, the aerogel component can be a silica silicate having an average particle size of 5-15 microns, a porosity of 90% or more, a bulk density of 40-100 kg/m³, and a surface area of 600-800 m²/g. Of course, materials having one or properties outside of these ranges can be used, as desired.

Depending upon the properties of the aerogel components, the aerogel components can be used as is, or they can be chemically modified. For example, aerogel surface chemistries may be modified for various applications, for example, the aerogel surface may be modified by chemical substitution upon or within the molecular structure of the aerogel to have hydrophilic or hydrophobic properties. For example, chemical modification may be desired so as to improve the hydrophobicity of the aerogel components. When such chemical treatment is desired, any conventional chemical treatment well known in the art can be used. For example, such chemical treatments of aerogel powders can include replacing surface hydroxyl groups with organic or partially fluorinated organic groups, or the like.

In general, a wide range of aerogel components are known in the art and have been applied in a variety of uses. For example, many aerogel components, including ground hydrophobic aerogel particles, have been used as low cost additives in such formulations as hair, skincare, and antiperspirant compositions. One specific non-limiting example is the commercially available powder that has already been chemically treated, Dow Corning VM-2270 Aerogel fine particles, having a size of about 5-15 microns.

The release layer 24 has a surface free energy that depends on the fluoropolymer and the roughness of the inner layer 28. In embodiments release layer 24 described herein produces a surface layer having a surface energy of less than 20 mN/m². In embodiments the surface free energy is less than 10 mN/m² for a superhydrophobic surface, or between 10 mN/m² and 2 mN/m², or is between 10 mN/m² and 5 mN/m², or is between 10 mN/m² and 7 mN/m².

The composition of inner layer 28 and the outermost layer 29 is coated on a substrate to form a release layer 24 in any suitable known manner. Typical techniques for coating such materials on the substrate layer include flow coating, liquid spray coating, dip coating, wire wound rod coating, fluidized bed coating, powder coating, electrostatic spraying, sonic spraying, blade coating, molding, laminating, and the like.

The method of spray coating involves dispersing a mixture of filler particles and fluoropolymer resin particles in a solvent that may be water; an alcohol such as methanol, ethanol, or isopropanol; a ketone such as actone, methyl ethyl ketone (MEK) or methyl isobutylketone (MIBK), or other suitable solvent. The dispersion can also contain dispersants, stabilizers, leveling agents, or other additives to improve dispersion quality or coating quality. Following dispersion of aerogel and fluoroplastic particles, the dispersion is sprayed onto a functional surface of fusing member, and following drying of the solvent, the component is heat treated to the required temperature to melt or cure the fluoropolymer and cure the topcoat layer.

The method of powder coating involves combining fillers and fluoropolymre resin powder and mixing by blending or another mixing system to produce a homogeneously mixed powder, then powder coating.

Flow coating is performed by applying a polymer solution dispensed between a blade and rotating fuser roll surface (rpm range between 40-200). The polymer solution is approximately 10-30% total solids weight basis in a pre-metered coating flow. The blade provides flow leveling around the roll circumference of the fuser substrate. The dispensing head and metering blade traverses along the length of the roll having a speed of about 2-20 mm/s so that the entire roll surface is coated in a spiral pattern. Successful flow coating conducted in this manner depends on coating rheology, blade angle, tip pressure, traverse speed, dispense rate and/or other factors as known to one of ordinary skill in the field of liquid film coating.

Specific embodiments will now be described in detail. These examples are intended to be illustrative, and not limited to the materials, conditions, or process parameters set forth in these embodiments. All parts are percentages by solid weight unless otherwise indicated.

### EXAMPLES

Shown below is a multi-layer coating wherein a surface coating is coated on a inner layer which minimizes print defects and achieves a low print gloss. Two sets of fuser rolls were prepared. A control roll of AO700 cured Viton (approximately 30 microns) containing about 5 weight percent aerogel particles was prepared by flow coating the composition on a silicone rubber intermediate layer and drying and curing the polymer. A dual-layer topcoat of AO700 cured Viton (approximately 25 microns) containing about 5 weight percent aerogel particles having a surface layer of AO700 cured Viton (approximately 4.5 microns) was prepared by flow coating the composition in the control on a silicone rubber intermediate layer. The composition was dried. A composition of AO700 and Viton was spray coated on the dried layer. Both layers were cured in an oven.

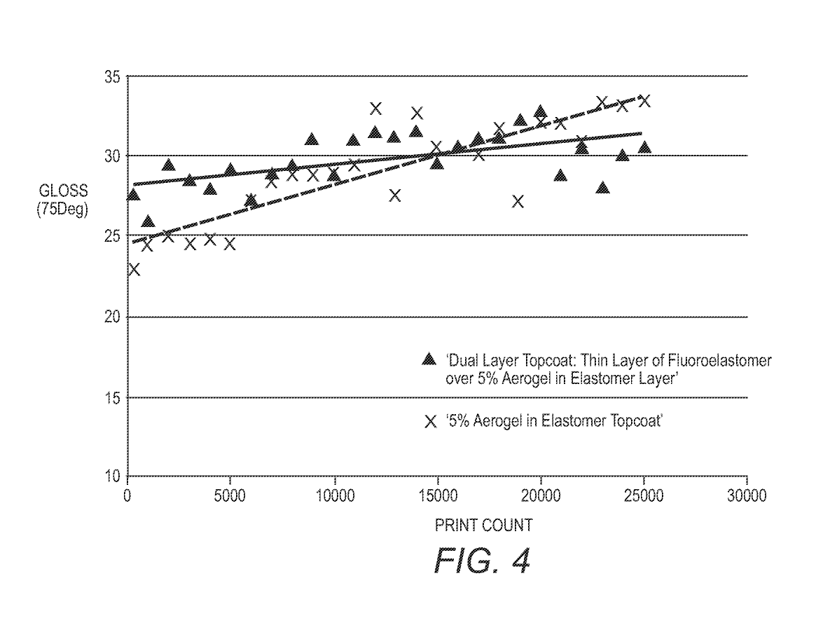

The rolls were oiled and tested in iGen3 using a 13 stripe target (on 8.5×11″ Digital Color Elite Gloss, 120 gsm) for 25,000 prints. The improvement of ‘break-in’ gloss by this approach is shown in FIG. 4, by the shallower slope of the gloss line (ideally this would be horizontal, and the dual layer design demonstrates a large shift in that direction, relative to the single layer approach.)

Multi-layer coating for fuser topcoats were prepared as follows. THVP221 (4.10 parts), metal oxide (0.787 part of magnesium oxide and 0.393 part of calcium hydroxide), and 1.68 parts of the bisphenol VC-50 curing agent (Viton® Curative No. 50 available from E. I. du Pont de Nemours, Inc.) were mixed in methyl isobutyl ketone (27.5 parts) to form a dispersion. To the dispersion was added 0.82 parts of Aerogel particles. The coating after solvent evaporation was cured at temperatures such as about 149° C. for 2 hours, about 177° C. for 2 hours, about 204° C. for 2 hours and at about 232° C. for 6 hours. A top coat was formed by forming a solution of Viton GF (4.10 parts), AO700 (0.82 parts) and methyl isobutylketone (60 parts). The resulting solution was flow-coated on top of the THV layer. The coating after solvent evaporation was cured at temperatures such as 49° C. for 2 hrs, 93° C. for 2hrs, 149° C. for 2 hrs, 177° C. for 2 hrs, 204° C. for 2 hrs, 218° C. for 10 hrs. The THV material had a modulus over 4500 psi while the Viton material had about 600 psi.

It will be appreciated that variants of the above-disclosed and other features and functions or alternatives thereof may be combined into other different systems or applications. Various presently unforeseen or unanticipated alternatives, modifications, variations, or improvements therein may be subsequently made by those skilled in the art, which are also encompassed by the following claims.

What is claimed is:

1. A coating comprising:
a inner layer comprising a first modulus and a first roughness; and
a surface layer comprising a second modulus wherein the first modulus is greater than the second modulus wherein when the coating is subjected to a nip pressure a surface of the coating exhibits a surface roughness approximately equal to the first roughness.

2. The coating of claim 1, wherein the inner layer comprises a polymer binder having dispersed therein a filler

3. The coating of claim 2, wherein the filler is selected from the group consisting of carbon blacks, carbon nanotubes, graphite, graphene, aerogels, metal oxides, doped metal oxides, aerogel particles, and mixtures thereof

4. The coating of claim 2, wherein the polymer binder comprises fluoroplastic.

5. The method of claim 2, wherein said fluoroplastic comprises a material selected from the group consisting of polytetrafluoroethylene (PTFE), perfluoroalkoxy polymer resin (PFA), copolymers of polytetrafluoroethylene and perfluoromethylvinylether and mixtures thereof.

6. The coating of claim 2, wherein the filler comprises aerogel particles selected from the group consisting of silica, carbon, alumina, titania and zirconia.

7. The coating of claim 6, wherein the aerogel particles comprise a surface area of from about 400 m²/g to about 1200 m²/g.

8. The coating of claim 6, wherein the aerogel particles comprise surface functionalities selected from the group consisting of alkylsilane, alkylchlorosilane, alkylsiloxane, polydimethylsiloxane, aminosilane and methacrylsilane.

9. The coating of claim 1, wherein the first modulus is from about 500 to about 10,000, and the second modulus is from about 200 to about 2,000.

10. The coating of claim 1, wherein the inner layer comprises a roughness of from about 1.5 μm to about 6.0 μm.

11. The coating of claim 1, wherein the surface layer comprises a fluoroelastomer selected from the group consisting of 1) copolymers of two of vinylidenefluoride, hexafluoropropylene, and tetrafluoroethylene; 2) terpolymers of vinylidenefluoride, hexafluoropropylene, and tetrafluoroethylene; and 3) tetrapolymers of vinylidenefluoride, hexafluoropropylene, tetrafluoroethylene, and a cure site monomer.

12. A fuser member comprising:
a substrate;
a functional layer disposed on the substrate; and
an outer coating disposed on the functional layer wherein the outer coating comprises a inner layer comprising a first modulus and a first roughness and a surface layer comprising a second modulus wherein the first modulus is greater than the second modulus wherein when the coating is subjected to a nip pressure a surface of the coating exhibits a surface roughness approximately equal to the first roughness.

13. The fuser member of claim 12, wherein the inner layer comprises fluoroplastic have dispersed therein aerogel particles.

14. The fuser member of claim 13, wherein the fluoroplastic comprises a material selected from the group consisting of polytetrafluoroethylene (PTFE), perfluoroalkoxy polymer resin (PFA), copolymers of polytetrafluoroethylene and perfluoromethylvinylether and mixtures thereof.

15. The fuser member of claim 12, wherein the inner layer comprises fluoroplastic having an embossed roughness.

16. The fuser member of claim 12, wherein the first modulus is from about 500 to about 10,000, and the second modulus is from about 200 to about 2,000.

17. The fuser member of claim 12, wherein the inner layer comprises a roughness of from about 1.5 μm to about 6.0 μm

18. A coating comprising:
a inner layer comprising fluoroelastomer having dispersed therein aerogel particles wherein the first layer has a modulus of from about 500 to about 5,000; and
a surface layer comprising a fluoroelastomer disposed on the inner layer comprising a thickness of from about 1 μm to about 20 μm.

19. The coating of claim 18, wherein the inner layer comprises a gloss of from about 3 ggu to about 60 ggu at 75 gloss average.

20. The coating of claim 18, wherein the fluoroelastomer is selected from the group consisting of 1) copolymers of two of vinylidenefluoride, hexafluoropropylene, and tetrafluoroethylene; 2) terpolymers of vinylidenefluoride, hexafluoropropylene, and tetrafluoroethylene; and 3) tetrapolymers of vinylidenefluoride, hexafluoropropylene, tetrafluoroethylene, and a cure site monomer.
